(19) United States
(12) Patent Application Publication
(10) Pub. No.: US 2026/0367236 A1
(43) Pub. Date: Nov. 19, 2026

(54) OBSTACLE DETECTION SYSTEM AND OBSTACLE DETECTION METHOD FOR MARINE VESSEL

(71) Applicant: YAMAHA HATSUDOKI KABUSHIKI KAISHA, Iwata-shi (JP)

(72) Inventor: Akihiro TAGATA, Shizuoka (JP)

(21) Appl. No.: 19/663,954

(22) Filed: Apr. 30, 2026

(30) Foreign Application Priority Data
May 16, 2025 (JP) 2025-082680

(51) Int. Cl. G01S 13/04; G01S 7/41

(52) U.S. Cl. CPC G01S 13/04; G01S 7/411

(57) ABSTRACT

An obstacle detection system for a marine vessel includes a sensor and a controller. The sensor is configured to detect a plurality of objects and to output a plurality of detection signals. The controller is configured or programmed to determine whether each of the objects is an obstacle based on the plurality of detection signals. The controller is further configured or programmed to extract, from the plurality of detection signals, detection signals having an intensity higher than a threshold, extend a retention time of each extracted detection signal, and determine whether an object among the plurality of objects is an obstacle based on a comparison between the extended retention time of the extracted detection signals and a determination time.

### CROSS-REFERENCE TO RELATED APPLICATIONS

This application claims the benefit of priority to Japanese Patent Application No. 2025-082680, filed on May 16, 2025, the entire contents of which are incorporated herein by reference.

### BACKGROUND OF THE INVENTION

### 1. Field of the Invention

The present invention relates to obstacle detection systems and obstacle detection methods for marine vessels including sensors configured to detect a plurality of objects.

### 2. Description of the Related Art

Technologies have been developed for performing autonomous navigation of a marine vessel based on information on obstacles detected by a sensor such as radar. However, objects detected by radar may include not only actual obstacles but also noise caused by natural phenomena, such as rainfall or waves. In this regard, U.S. Patent Application Publication No. 2024/0419168 discloses a technique in which objects are detected using radar and mapped while objects with a reflected wave intensity at or below a threshold are excluded. As a result, noise caused by rainfall can be removed from object mapping data, and only objects important for autonomous navigation (e.g., docks, other vessels, and large buoys) can be recognized, thus improving the accuracy of route planning and maneuvering control during autonomous navigation.

However, since the intensity of noise caused by natural phenomena varies depending on conditions, when a single fixed threshold is used, it may not be possible to appropriately remove noise caused by natural phenomena from the objects detected by radar. Therefore, there is still room for improvement in obstacle detection using sensors.

### SUMMARY OF THE INVENTION

Example embodiments of the present invention are directed to technologies for improving the accuracy of obstacle detection by sensors.

According to an example embodiment of the present invention, an obstacle detection system for a marine vessel includes a sensor and a controller. The sensor is configured to detect a plurality of objects and to output a plurality of detection signals. The controller is configured or programmed to determine whether each of the objects is an obstacle based on the plurality of detection signals. Specifically, the controller is configured or programmed to extract, from the plurality of detection signals, detection signals having an intensity higher than a threshold, extend a retention time of each extracted detection signal, and determine whether an object among the plurality of objects is an obstacle based on a comparison between the extended retention time of the extracted detection signals and a determination time.

According to another example embodiment of the present invention, the controller may be configured or programmed to determine that an object corresponding to a detection signal having an intensity equal to or higher than a threshold is an obstacle, and to change the threshold in accordance with a condition of a water surface on which the marine vessel is located.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram illustrating a configuration of a marine vessel according to a first example embodiment of the present invention.

FIG. 2 is a block diagram schematically illustrating a configuration of a maneuvering system provided in the marine vessel of FIG. 1.

FIG. 3 is a graph for explaining the concept of a filtering process performed by the maneuvering system of FIG. 2.

FIG. 4 is a diagram illustrating a case in which a slow-speed buoy is present as an obstacle ahead of the marine vessel.

FIGS. 5A and 5B are graphs illustrating a relationship between the intensity of reflected waves and the pitch angle of the marine vessel under strong wind conditions and weak wind conditions.

FIG. 6 is a block diagram illustrating a configuration of an obstacle determination system according to the first embodiment.

FIGS. 7A and 7B are graphs illustrating a relationship between detection signals of objects detected by a millimeter-wave radar and a duration for which the detection signals are retained.

FIGS. 8A and 8B are graphs for explaining adding additional time to a retention time of a detection signal in a case where only reflected waves from a rough water surface under strong wind conditions are detected.

FIGS. 9A and 9B are graphs for explaining adding additional time to a retention time of a detection signal in a case where a slow-speed buoy is detected as an obstacle.

FIGS. 10A to 10D are process diagrams illustrating an obstacle determination process performed in a case where, under weak wind conditions, no obstacle is present around the marine vessel and only reflected waves from a calm water surface are detected.

FIGS. 11A to 11D are process diagrams illustrating an obstacle determination process performed in a case where, under strong wind conditions, no obstacle is present around the marine vessel and only reflected waves from a rough water surface are detected.

FIGS. 12A to 12D are process diagrams illustrating an obstacle determination process performed in a case where a slow-speed buoy is detected as an obstacle present ahead of the marine vessel.

FIG. 13 is a block diagram illustrating a configuration of an obstacle determination system according to a second example embodiment of the present invention.

### DETAILED DESCRIPTION OF THE EXAMPLE EMBODIMENTS

Example embodiments of the present invention will be described in detail below with reference to the accompanying drawings.

In one example embodiment of the present invention, an obstacle detection system for a marine vessel extracts detection signals each having an intensity equal to or higher than a threshold from a plurality of detection signals output from a sensor. In addition, the obstacle detection system extends retention times of the extracted detection signals and compares the extended retention times with a determination time to determine whether an object is an obstacle. Therefore, compared with a case where an obstacle is detected using a single fixed threshold, a detection signal caused by noise is less likely to be detected as an obstacle. As a result, the accuracy of obstacle detection by the sensor can be improved.

First, a description will be provided of a first example embodiment of the present invention.

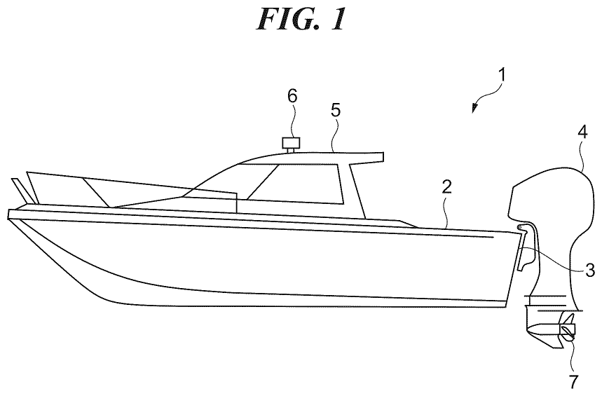

FIG. 1 is a schematic diagram illustrating a configuration of a marine vessel according to the first example embodiment. As illustrated in FIG. 1, a marine vessel 1 may be a planning boat and includes a hull 2 and, for example, two outboard motors 4 as propulsion devices attached to a stern 3 of the hull 2. The hull 2 includes a cabin 5 that also serves as a cockpit, and a millimeter-wave radar 6 (sensor) is arranged on the cabin 5. Although the marine vessel 1 illustrated in FIG. 1 is assumed to be a planning boat, the marine vessel 1 is not limited thereto and may be, for example, a relatively small displacement-type vessel. In addition, the millimeter-wave radar 6 is not necessarily located on the cabin 5, and may be arranged at a bow or on a side of the hull 2.

The outboard motors 4 each include an internal combustion engine or an electric motor (not illustrated) as a power source. Each outboard motor 4 applies thrust to the marine vessel 1 by a propeller 7 that is rotated by a driving force generated by the power source. The number of outboard motors 4 provided in the marine vessel 1 is not limited to two, and the marine vessel 1 may include only one outboard motor 4 or may include three or more outboard motors 4. In addition, the marine vessel 1 may be provided with an inboard motor or an inboard/outboard motor as a propulsion device instead of the outboard motors 4. Furthermore, the marine vessel 1 may be a jet-propelled boat.

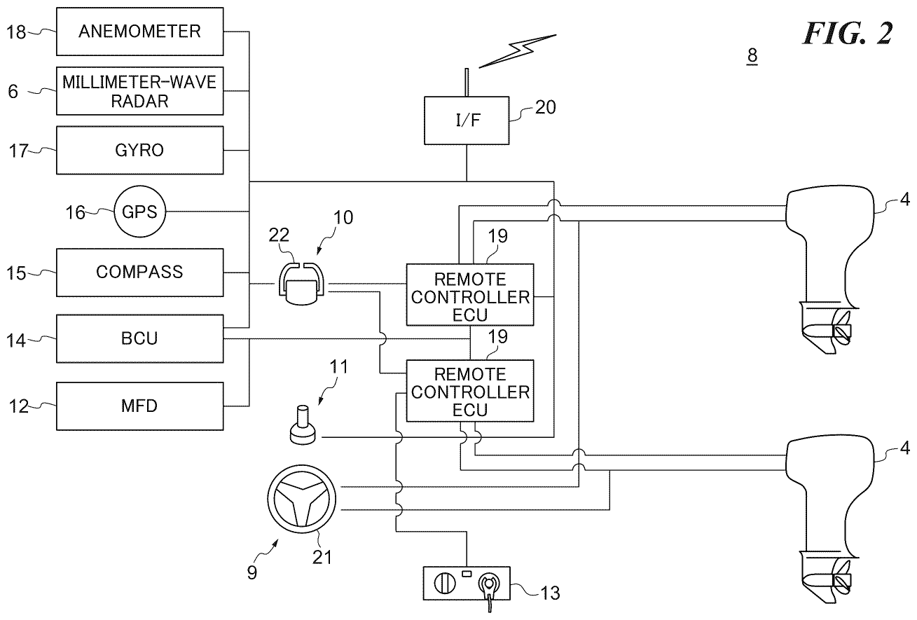

FIG. 2 is a block diagram schematically illustrating a configuration of a maneuvering system 8 provided in the marine vessel 1 of FIG. 1. As illustrated in FIG. 2, the maneuvering system 8 includes the outboard motors 4, a steering mechanism 9, a remote controller 10, a joystick 11, a multi-function display (MFD) 12, a main switch 13, a boat control unit (BCU) 14, a compass 15, a GPS 16, a gyro 17, the millimeter-wave radar 6, an anemometer 18, remote controller electronic control units (ECUs) 19, and a communication interface (I/F) 20. The components of the maneuvering system 8 are communicatively connected to each other. In addition, one remote controller ECU 19 is provided for each of the outboard motors 4. Note that the maneuvering system 8 is not required to include both the gyro 17 and the anemometer 18, and may include only one of them.

The steering mechanism 9 includes a steering wheel 21, and transmits, to each remote controller ECU 19, a steering angle signal corresponding to a rotation operation of the steering wheel 21 performed by an operator. The remote controller 10 includes levers 22 corresponding to the respective remote controller ECUs 19, and transmits, to each remote controller ECU 19, a signal (such as a forward signal or a reverse signal) corresponding to an operation of each lever 22 performed by the operator. The joystick 11 transmits, to each remote controller ECU 19, a signal corresponding to a tilt direction and a tilt amount based on an operation performed by the operator. The MFD 12 may be, for example, a color LCD display and functions as a display that displays various types of information. The MFD 12 also functions as a touch panel that receives input from the operator and transmits a signal corresponding to the received operator input to the BCU 14 and each remote controller ECU 19.

The main switch 13 receives an instruction to power on or start each outboard motor 4, and transmits a signal corresponding to the received instruction to the BCU 14 and each remote controller ECU 19. The BCU 14 identifies the status of the marine vessel 1 based on signals received from the respective components of the maneuvering system 8. The BCU 14 then determines the magnitude of thrust to be generated by each outboard motor 4 and the direction in which the thrust is to be applied, and transmits a control signal to each remote controller ECU 19.

The compass 15 detects the heading (bow direction) of the marine vessel 1 and transmits information on the heading of the marine vessel 1 to the BCU 14. The GPS 16 detects the current position of the marine vessel 1 and transmits position information indicating the current position of the marine vessel 1 to the BCU 14. The gyro 17 measures the pitch angle, roll angle, and vertical acceleration of the marine vessel 1, and outputs these pieces of information to the BCU 14. The anemometer 18 measures the wind speed in the vicinity of the marine vessel 1 and transmits information on the measured wind speed to the BCU 14.

The millimeter-wave radar 6 irradiates electromagnetic waves, specifically radio waves in a millimeter-wave band, around the marine vessel 1 to detect objects such as obstacles and the water surface in the vicinity of the marine vessel 1, thus determining surrounding conditions of the marine vessel 1. The millimeter-wave radar 6 outputs, to the BCU 14, detection signals including the intensity of reflected waves from the detected objects and position data of the detected objects. The communication I/F 20 communicates with an external server or the like outside the marine vessel 1 and transmits signals received from the outside to the BCU 14.

The remote controller ECUs 19 each adjust the magnitude and direction of thrust generated by a corresponding one of the outboard motors 4 in accordance with signals received from the BCU 14, the remote controller 10, the joystick 11, or the like. Accordingly, in the maneuvering system 8, the operator can control the speed and heading (bow direction) of the marine vessel 1 by operating the joystick 11 or the levers 22 of the remote controller 10.

As described above, in the maneuvering system 8, the millimeter-wave radar 6 outputs, to the BCU 14, detection signals including position data (a direction and a distance from the marine vessel 1) of detected objects around the marine vessel 1. However, since the millimeter-wave radar 6 detects reflected waves from not only obstacles but also rainfall and the water surface, the objects detected by the millimeter-wave radar 6 include not only actual obstacles but also noise caused by rainfall or the water surface. Therefore, in order to use the position data of the objects included in the detection signals output from the millimeter-wave radar 6 for displaying obstacles on the MFD 12 or for autonomous navigation of the marine vessel 1, it is necessary to determine whether each object detected by the millimeter-wave radar 6 is an actual obstacle or noise. Note that the term “obstacle” as used herein refers to an object around the marine vessel 1 detected by the millimeter-wave radar 6, regardless of whether the object may interfere with navigation of the marine vessel 1.

To address this, in an example embodiment, a filtering process is performed to determine whether an object detected by the millimeter-wave radar 6 is an obstacle or noise. In an example embodiment, the filtering process is performed by the BCU 14; however, the maneuvering system 8 may include a separate recognition processor independent of the BCU 14, and the recognition processor may perform the filtering process.

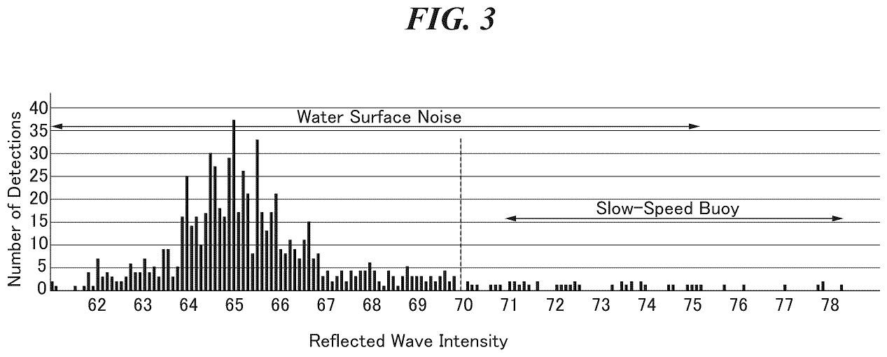

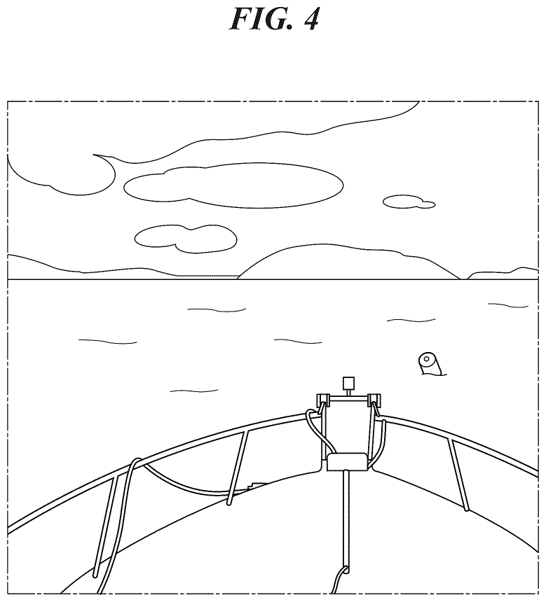

FIG. 3 is a graph for explaining the concept of the filtering process performed by the maneuvering system 8 of FIG. 2. In FIG. 3, the horizontal axis represents the intensity of reflected waves (in dB) from objects detected by the millimeter-wave radar 6, and the vertical axis represents the number of detections of reflected waves for each reflected wave intensity within a predetermined period. The graph of FIG. 3 illustrates a case in which a slow-speed buoy is present as an obstacle ahead of the marine vessel 1, as illustrated in FIG. 4.

In the example illustrated in FIG. 3, the intensity of reflected waves from the water surface is distributed over a range from approximately 60 dB to approximately 75 dB (see the range labeled “Water Surface Noise” in the figure), whereas the intensity of reflected waves from the slow-speed buoy, which is an obstacle, is distributed over a range from approximately 71 dB to approximately 78 dB. Accordingly, objects from which reflected waves having an intensity of 70 dB or less are received can be determined to be noise. Therefore, in the filtering process according to an example embodiment, 70 dB is used as a threshold for the reflected wave intensity. Specifically, detection signals including reflected wave intensities at or below the threshold are removed as noise, while detection signals including reflected wave intensities higher than the threshold are extracted, and the objects corresponding to the extracted detection signals are determined to be obstacles. In other words, the filtering process performed by the maneuvering system 8 may be regarded as a filtering process using a high-pass filter having a threshold of 70 dB.

In the filtering process performed by the maneuvering system 8 described above, the threshold used for obstacle determination is set to 70 dB. However, because the state of the water surface differs between strong wind conditions and weak wind conditions, the distribution pattern of the intensity of reflected waves from the water surface also differs, making it difficult to use the same threshold under both conditions.

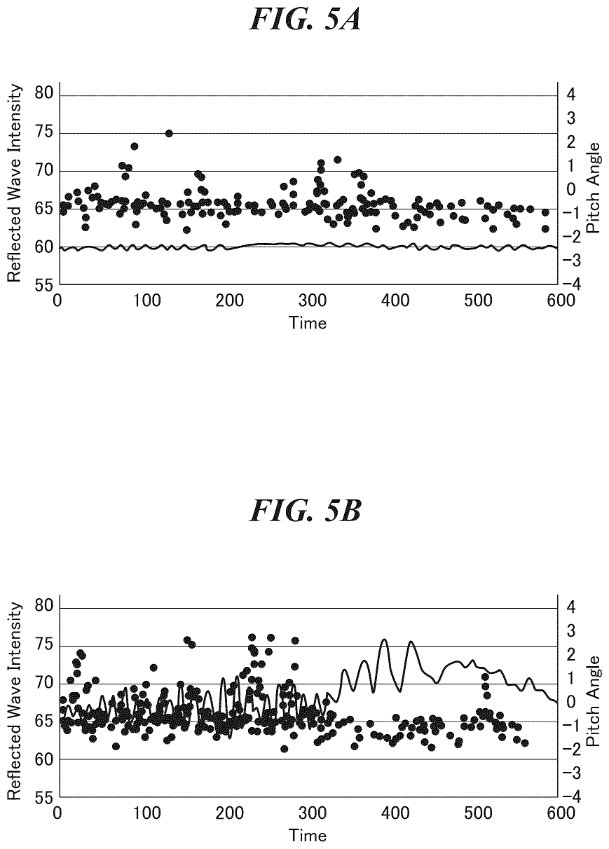

FIGS. 5A and 5B are graphs illustrating a relationship between the intensity of reflected waves and the pitch angle of the marine vessel 1 under strong wind conditions and weak wind conditions. In these graphs, the horizontal axis represents elapsed time (in units of 1/10 second), and the vertical axis represents the intensity of reflected waves (in dB) included in detection signals output from the millimeter-wave radar 6, as well as the pitch angle of the marine vessel 1 output from the gyro 17. In FIGS. 5A and 5B, the reflected wave intensity is indicated by dots (●), and the pitch angle of the marine vessel 1 is indicated by a solid line. In FIGS. 5A and 5B, the graphs represent cases in which no obstacle is present around the marine vessel 1 and only reflected waves from the water surface are detected. FIG. 5A illustrates a distribution pattern of detection signals including reflected waves from the water surface under weak wind conditions, and FIG. 5B illustrates a distribution pattern of detection signals including reflected waves from the water surface under strong wind conditions.

Comparing the graph of FIG. 5A with the graph of FIG. 5B, it can be confirmed that the fluctuation range of the intensity of reflected waves increases under strong wind conditions. This is considered to be because the water surface becomes rougher as the wind becomes stronger, making it more likely that reflected waves having high intensity are generated from the water surface. It can also be confirmed that, under strong wind conditions, detection signals including reflected wave intensities of 70 dB or higher are generated far more frequently than under weak wind conditions. Therefore, if the threshold used for obstacle determination remains set at 70 dB under strong wind conditions, the likelihood increases that reflected waves from the water surface may be erroneously determined as reflected waves from obstacles. As a result, the water surface is more likely to be erroneously displayed as an obstacle on the MFD 12, and it becomes difficult to use the position data of objects included in detection signals output from the millimeter-wave radar 6 for autonomous navigation of the marine vessel 1.

To address this, according to an example embodiment, the BCU 14 changes the threshold used for obstacle determination in accordance with the condition of the water surface on which the marine vessel 1 is located. For example, under weak wind conditions where the water surface is not severely disturbed, the threshold used for obstacle determination is set to, for example, 70 dB. On the other hand, under strong wind conditions where the water surface is severely disturbed, since reflected waves having intensities higher than 75 dB are not frequently generated, the threshold used for obstacle determination under strong wind conditions is set to, for example, 75 dB. This reduces the likelihood of erroneously determining reflected waves from the water surface as reflected waves from an obstacle under strong wind conditions. As described above, the intensity of reflected waves from a slow-speed buoy is distributed over a range from approximately 71 dB to approximately 78 dB. Accordingly, even when the threshold used for obstacle determination is set to 75 dB, reflected waves from the slow-speed buoy can still be determined as reflected waves from an obstacle. Note that the numerical values of the threshold used for obstacle determination described above are merely examples, and the numerical value of the threshold used for obstacle determination may be appropriately changed in accordance with the conditions around the marine vessel 1.

In the example described above, two thresholds are set for use in obstacle determination: a threshold for weak wind conditions and a threshold for strong wind conditions. However, the method of setting the threshold used for obstacle determination is not limited thereto. For instance, a total of three thresholds may be set by providing an additional threshold for moderate wind conditions between the threshold for weak wind conditions and the threshold for strong wind conditions. In addition, the threshold used for obstacle determination may be varied linearly. For example, the threshold used for obstacle determination may be increased as the wind becomes stronger and the water surface on which the marine vessel 1 is located becomes rougher.

Furthermore, from a comparison between the graph of FIG. 5A and the graph of FIG. 5B, it can be confirmed that the magnitude of variation in the pitch angle of the marine vessel 1 under strong wind conditions is greater than that under weak wind conditions. In other words, under strong wind conditions where the water surface is severely disturbed, the pitch angle of the marine vessel 1 is considered to exhibit greater variation.

Accordingly, the BCU 14 can determine whether the water surface on which the marine vessel 1 is located is rough based on the pitch angle of the marine vessel 1. In addition, as described above, since it is considered that the water surface becomes rougher as the wind becomes stronger, the BCU 14 can determine whether the water surface on which the marine vessel 1 is located is rough based on the wind speed in the vicinity of the marine vessel 1. Furthermore, as the roughness of the water surface increases, the motion of the marine vessel 1 becomes greater; therefore, it is considered that not only the pitch angle of the marine vessel 1 but also the roll angle and the vertical acceleration of the marine vessel 1 exhibit greater variation. Accordingly, the BCU 14 can also determine whether the water surface on which the marine vessel 1 is located is rough based on the roll angle of the marine vessel 1 or the vertical acceleration of the marine vessel 1. Therefore, according to an example embodiment, the BCU 14 may determine whether the water surface on which the marine vessel 1 is located is rough based on at least one of the pitch angle of the marine vessel 1, the roll angle of the marine vessel 1, the vertical acceleration of the marine vessel 1, or the wind speed in the vicinity of the marine vessel 1, and may set the threshold used for obstacle determination in accordance with the result of the determination. In this case, in order to vary the threshold used for obstacle determination linearly, the threshold used for obstacle determination may be prepared as a map. This map may be a single-axis map using any one of the pitch angle of the marine vessel 1, the roll angle of the marine vessel 1, the vertical acceleration of the marine vessel 1, and the wind speed in the vicinity of the marine vessel 1 as a parameter, or may be a multi-axis map using two or more of the pitch angle of the marine vessel 1, the roll angle of the marine vessel 1, the vertical acceleration of the marine vessel 1, and the wind speed in the vicinity of the marine vessel 1 as parameters.

Note that the information used by the BCU 14 to determine whether the water surface on which the marine vessel 1 is located is rough is not limited to those described above. For example, an image captured of the water surface may be used as information to determine whether the water surface is rough. In this case, the marine vessel 1 is provided with a camera (not illustrated), and the BCU 14 performs image processing on images captured by the camera to identify the wave height and wavelength of waves around the marine vessel 1. The BCU 14 then determines whether the water surface on which the marine vessel 1 is located is rough based on the wave height and the wavelength.

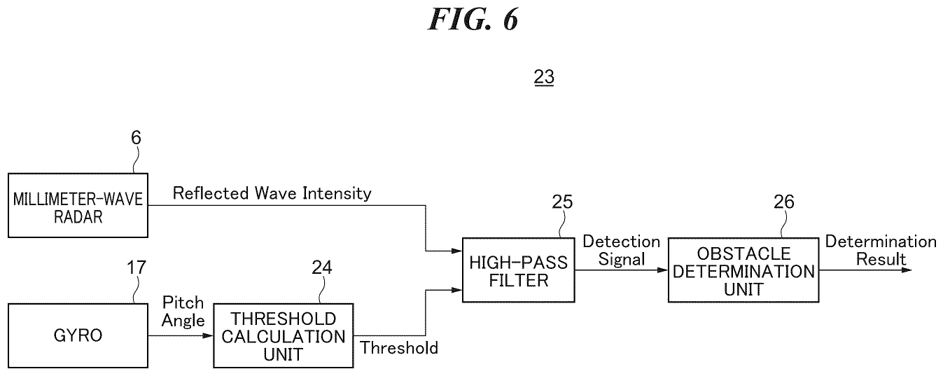

FIG. 6 is a block diagram illustrating a configuration of an obstacle determination system 23 (obstacle detection system) according to an example embodiment. The obstacle determination system 23 includes the millimeter-wave radar 6, the gyro 17, a threshold calculation unit 24, a high-pass filter 25, and an obstacle determination unit 26. The threshold calculation unit 24, the high-pass filter 25, and the obstacle determination unit 26 may be implemented as functional modules by the BCU 14 executing a predetermined program.

In the obstacle determination system 23, the millimeter-wave radar 6 outputs detection signals including the intensity of reflected waves to the high-pass filter 25, and the gyro 17 outputs the pitch angle of the marine vessel 1 to the threshold calculation unit 24. The threshold calculation unit 24 determines whether the water surface on which the marine vessel 1 is located is rough based on the received pitch angle of the marine vessel 1. The threshold calculation unit 24 then sets a threshold to be used for obstacle determination in accordance with the result of the determination and outputs the threshold to the high-pass filter 25. The high-pass filter 25 performs a filtering process that compares the intensity of the reflected waves included in the detection signals with the received threshold. The high-pass filter 25 extracts detection signals including reflected wave intensities higher than the threshold and outputs the extracted detection signals to the obstacle determination unit 26. The obstacle determination unit 26 determines the objects corresponding to the extracted detection signals to be obstacles and outputs the determination result.

According to an example embodiment, the BCU 14 changes the threshold used for obstacle determination in accordance with the condition of the water surface on which the marine vessel 1 is located. For example, under strong wind conditions where the water surface is severely disturbed, the threshold used for obstacle determination is set higher than the threshold used under weak wind conditions where the water surface is not severely disturbed. This reduces the likelihood of erroneously determining reflected waves from the water surface as reflected waves from an obstacle under strong wind conditions, thus improving the accuracy of obstacle detection by the millimeter-wave radar 6.

Next, a description will be provided of a second example embodiment of the present invention. The second example embodiment differs from the first example embodiment in that whether an object detected by the millimeter-wave radar 6 is an obstacle or noise is determined based not only on a threshold of the reflected wave intensity but also on a duration for which a detection signal output by the millimeter-wave radar 6 is retained. Note that the following description will mainly focus on the differences in configuration and operation, and the same or duplicative explanations will not be repeated.

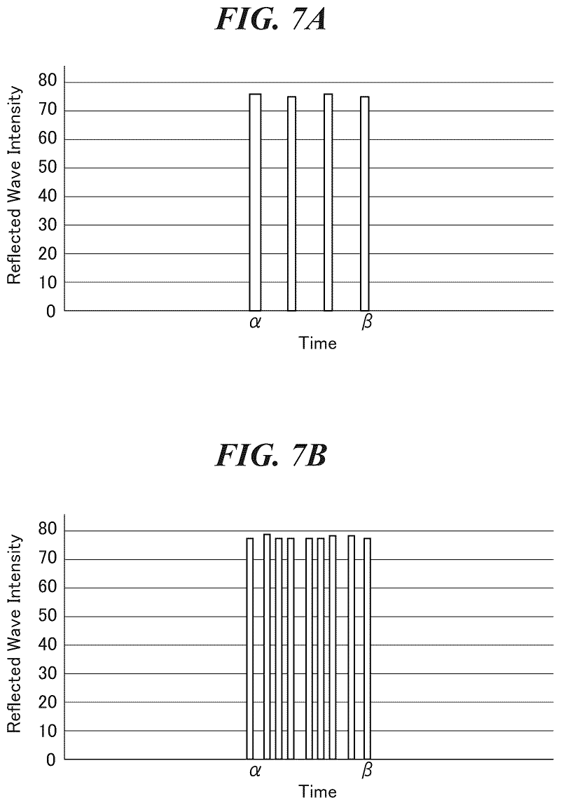

FIGS. 7A and 7B are graphs illustrating a relationship between detection signals of objects detected by the millimeter-wave radar 6 and a duration for which the detection signals are retained. In these graphs, the horizontal axis represents elapsed time, and the vertical axis represents the intensity of reflected waves included in the detection signals (in dB). The duration for which a detection signal is retained (hereinafter referred to as the “retention time”) refers to a period during which the detection signal continues, that is, a period during which the millimeter-wave radar 6 continues to detect an object and output the detection signal.

The graph of FIG. 7A illustrates a case under strong wind conditions in which no obstacle is present around the marine vessel 1 and only reflected waves from a rough water surface are detected. The graph of FIG. 7B illustrates a case in which a slow-speed buoy is detected as an obstacle located ahead of the marine vessel 1. In addition, the graphs in FIGS. 7A and 7B represent conditions after the filtering process described in the first example embodiment has been performed to extract detection signals including reflected wave intensities higher than a threshold. The threshold of the reflected wave intensity used in this filtering process is 75 dB.

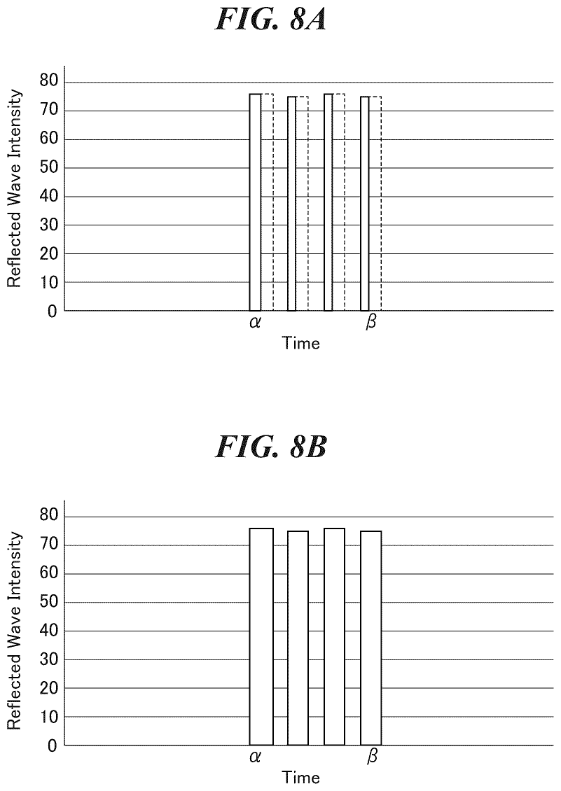

For ease of understanding, the graphs of FIGS. 7A and 7B indicate only detection signals of objects detected during a period from time α to time β, and illustration of detection signals of objects detected before time α or after time β is omitted. Note that, also in FIGS. 8A to 12D described below, illustration of detection signals of objects detected before time α or after time β is omitted.

As described in the first example embodiment, under strong wind conditions where the water surface is severely disturbed, detection signals including reflected wave intensities higher than 75 dB do not occur frequently, but are not completely eliminated. Therefore, even if the threshold of the reflected wave intensity used in the filtering process is set to 75 dB, some detection signals may still be extracted as illustrated in FIG. 7A. As a result, there is a possibility that the BCU 14 may erroneously determine reflected waves from the water surface as reflected waves from an obstacle. Accordingly, in order to further improve the accuracy of obstacle detection by the millimeter-wave radar 6, obstacle detection may be performed by taking into account not only the filtering process using a threshold of the reflected wave intensity but also other factors.

Furthermore, on a rough water surface under strong wind conditions, waves having high wave heights do not occur continuously, and even when such high waves occur, they do not persist for a long period of time. Accordingly, when the millimeter-wave radar 6 irradiates radio waves toward a rough water surface under strong wind conditions, reflected waves having high intensity are not generated continuously. As a result, as illustrated in FIG. 7A, a plurality of detection signals extracted by the filtering process do not occur continuously, but occur only intermittently. On the other hand, a slow-speed buoy serving as an obstacle is a solid object and stably reflects radio waves irradiated from the millimeter-wave radar 6. Therefore, when the millimeter-wave radar 6 irradiates radio waves toward the slow-speed buoy, reflected waves having high intensity are generated continuously, and a plurality of detection signals extracted by the filtering process occur continuously and densely, as illustrated in FIG. 7B.

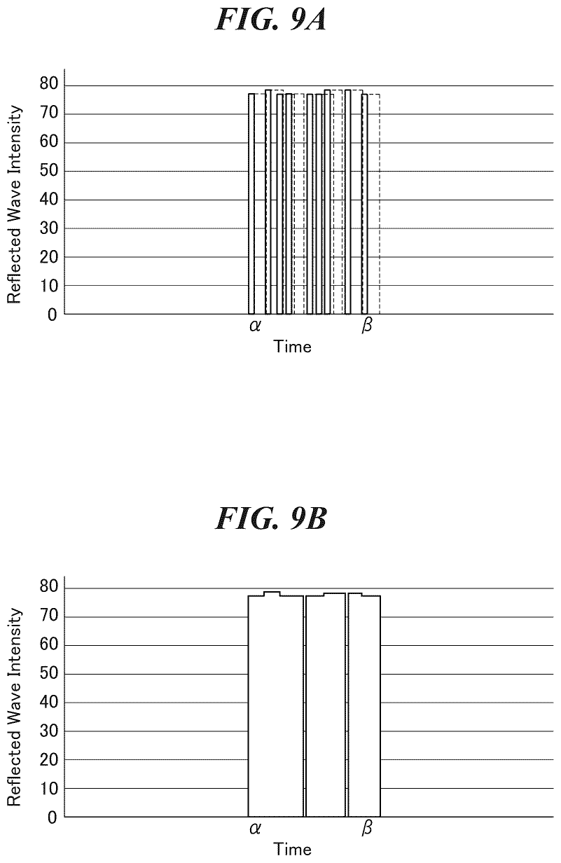

Here, a case is considered in which, when only reflected waves from a rough water surface are detected under strong wind conditions, the retention time of each detection signal is extended by adding an additional time (extension time) as illustrated in FIG. 8A (see dashed lines in the figure). However, as described above, when only reflected waves from a rough water surface are detected under strong wind conditions, a plurality of detection signals extracted by the filtering process occur intermittently. Therefore, even if the retention time of each detection signal is extended, temporally adjacent detection signals do not merge with each other, and the retention time of a detection signal is not extended beyond the added additional time, as illustrated in FIG. 8B. On the other hand, when a slow-speed buoy is detected as an obstacle, as described above, a plurality of detection signals extracted by the filtering process occur continuously and densely. Accordingly, when the retention time of each detection signal is extended by adding the additional time (see dashed lines in the figure), as illustrated in FIG. 9A, temporally adjacent detection signals merge with each other, and the retention time of the merged detection signal becomes significantly longer than a time obtained by adding the additional time to the retention time of a single detection signal, as illustrated in FIG. 9B.

In other words, by performing an extension process in which an additional time is added to the retention time of each detection signal, the retention times of detection signals after the extension process can be extended to a significantly greater extent when a slow-speed buoy is detected as an obstacle, compared to when only reflected waves from a rough water surface are detected under strong wind conditions.

Accordingly, in an example embodiment, an extension process is performed in addition to the filtering process used to extract a plurality of detection signals, and whether an object detected by the millimeter-wave radar 6 is an obstacle such as a slow-speed buoy or noise caused by a rough water surface is determined based on the retention time of the detection signals after the extension process. Specifically, the extension process is performed after a plurality of detection signals are extracted through the filtering process. If the retention time of the detection signals after the extension process does not exceed a threshold for the retention time (hereinafter referred to as the “determination time”), the object corresponding to the detection signals is determined to be noise caused by a rough water surface. On the other hand, if the retention time of the detection signals after the extension process exceeds the determination time, the object corresponding to the detection signals is determined to be an obstacle. In an example embodiment, the determination time is set to be longer than a time obtained by adding the additional time to the average retention time of a detection signal.

An obstacle determination process according to an example embodiment, which uses the filtering process and the extension process, will be described below.

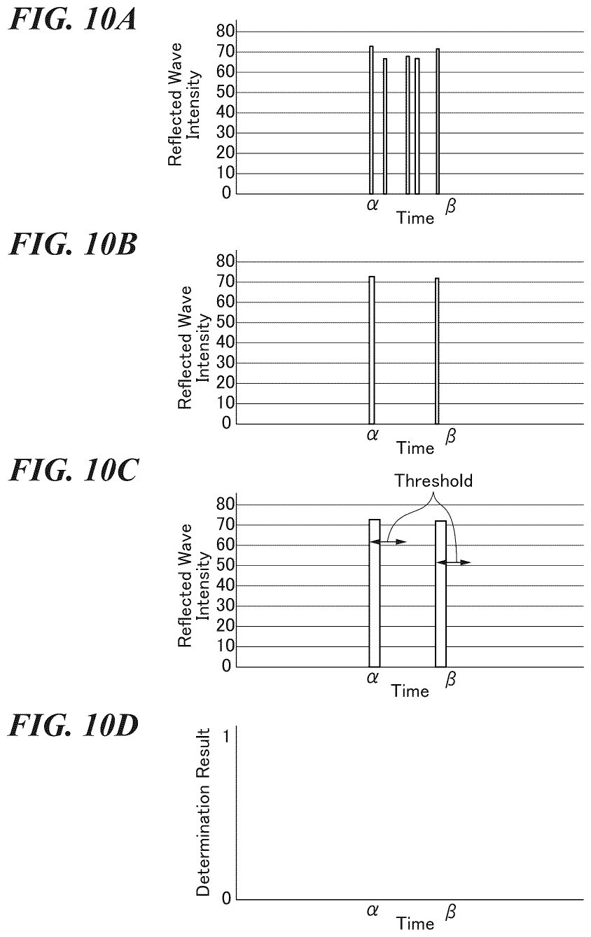

FIGS. 10A to 10D are process diagrams illustrating the obstacle determination process performed in a case where, under weak wind conditions, no obstacle is present around the marine vessel 1 and only reflected waves from a calm (non-rough) water surface are detected.

First, the filtering process is performed. Under weak wind conditions where the water surface is not rough, waves having high wave heights rarely occur. Accordingly, when the millimeter-wave radar 6 irradiates radio waves toward the water surface, reflected waves having high intensity are rarely generated, as illustrated in FIG. 10A. Therefore, even if the threshold of the reflected wave intensity used in the filtering process is set to 70 dB, only a very small number of detection signals are extracted, and the extracted detection signals occur intermittently, as illustrated in FIG. 10B.

Next, the extension process is performed. However, since the extracted detection signals occur intermittently, even when the additional time is added to the retention time of each detection signal, detection signals that are temporally adjacent to each other do not merge, and the retention time of each detection signal is not extended beyond the additional time. Accordingly, the retention time of the detection signals after the extension process does not exceed the determination time, as illustrated in FIG. 10C. As a result, the object corresponding to the detection signals after the extension process is determined to be noise. In the obstacle determination process according to an example embodiment, when the object corresponding to the detection signals is determined to be an obstacle, the determination result has a value of “1,” and when the object corresponding to the detection signals is determined to be noise, the determination result remains at a value of “0.” Therefore, in a situation where only reflected waves from a calm water surface are detected, the value of the determination result is maintained at “0,” as illustrated in FIG. 10D.

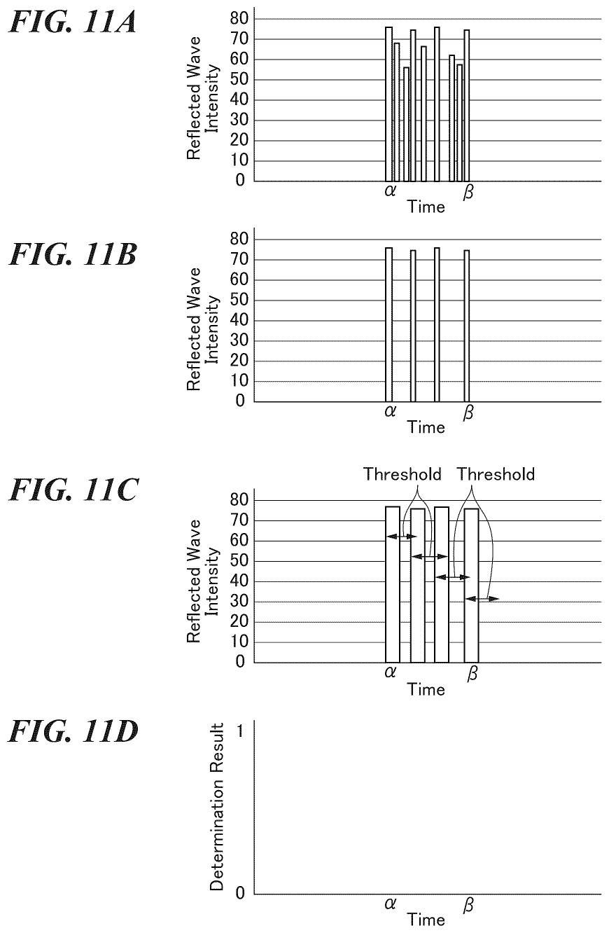

FIGS. 11A to 11D are process diagrams illustrating the obstacle determination process performed in a case where, under strong wind conditions, no obstacle is present around the marine vessel 1 and only reflected waves from a rough water surface are detected.

First, the filtering process is performed. As described above, when the millimeter-wave radar 6 irradiates radio waves toward a rough water surface under strong wind conditions, some reflected waves having high intensity are generated; however, they are not generated continuously, as illustrated in FIG. 11A. Accordingly, although a larger number of detection signals are extracted by the filtering process than under weak wind conditions, the extracted detection signals still do not occur continuously and occur only intermittently, as illustrated in FIG. 11B. Note that, under strong wind conditions, the threshold of the reflected wave intensity used in the filtering process is set to 75 dB.

Next, the extension process is performed. However, since the extracted detection signals occur intermittently, even when the additional time is added to the retention time of each detection signal, detection signals that are temporally adjacent to each other do not merge, and the retention time of each detection signal is not extended beyond the additional time. Accordingly, as in the case under weak wind conditions, the retention time of the detection signals after the extension process does not exceed the determination time, as illustrated in FIG. 11C. As a result, the value of the determination result is maintained at “0,” as illustrated in FIG. 11D, and the object corresponding to the detection signals after the extension process is determined to be noise.

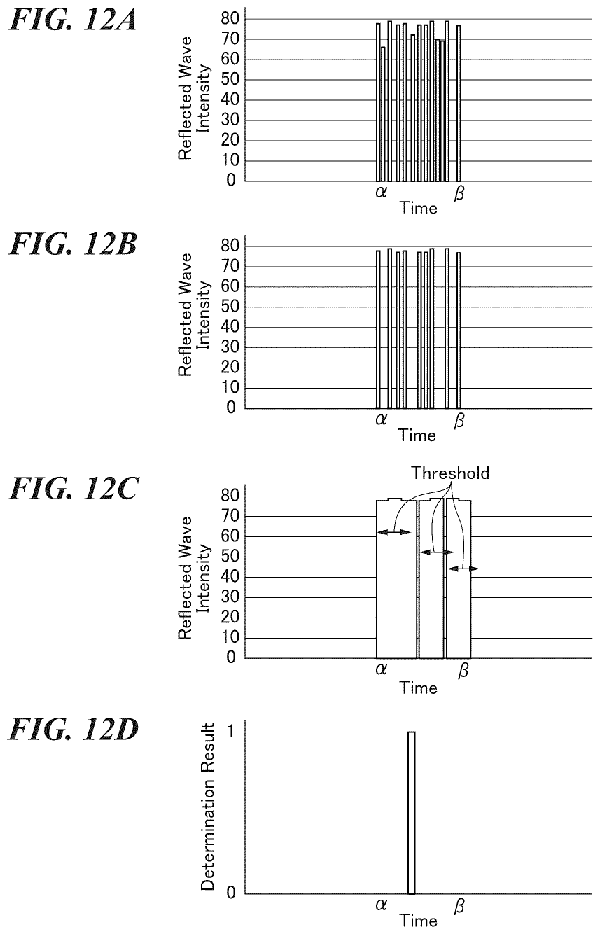

FIGS. 12A to 12D are process diagrams illustrating the obstacle determination process performed in a case where a slow-speed buoy is detected as an obstacle present ahead of the marine vessel 1.

First, the filtering process is performed. As described above, when the millimeter-wave radar 6 irradiates radio waves toward the slow-speed buoy, reflected waves having high intensity are generated continuously, as illustrated in FIG. 12A. Accordingly, a plurality of detection signals extracted by the filtering process also occur continuously and densely, as illustrated in FIG. 12B. Here again, the threshold of the reflected wave intensity used in the filtering process is set to 75 dB.

Next, the extension process is performed. At this time, since the extracted detection signals occur continuously and densely, when the additional time is added to the retention time of each detection signal, temporally adjacent detection signals merge with each other, and the retention time of the merged detection signal becomes significantly longer than a time obtained by adding the additional time to the retention time of a single detection signal. Accordingly, a detection signal after the extension process whose retention time exceeds the determination time is generated, as illustrated in FIG. 12C. As a result, after the retention time exceeds the determination time, the value of the determination result is changed to and maintained at “1” for a predetermined period of time, as illustrated in FIG. 12D, and the object corresponding to the detection signals after the extension process is determined to be an obstacle.

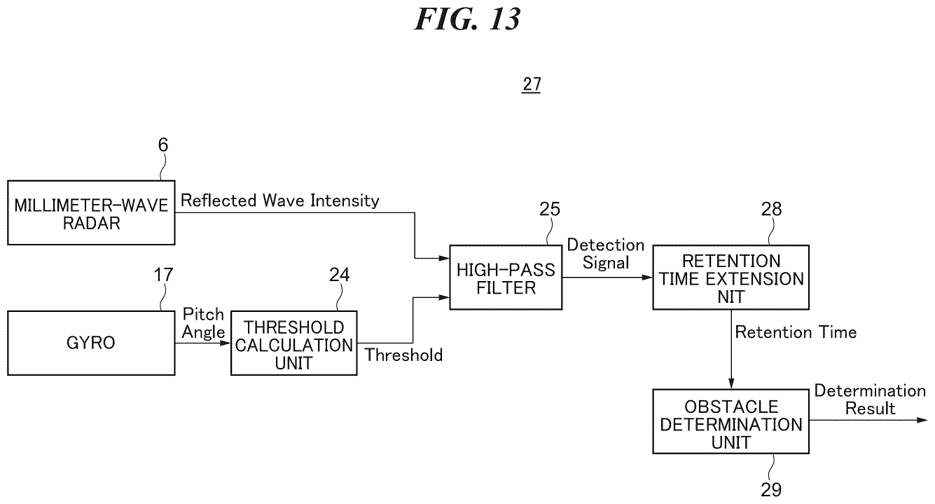

FIG. 13 is a block diagram illustrating a configuration of an obstacle determination system 27 (obstacle detection system) according to an example embodiment. Since the obstacle determination system 27 has a configuration substantially similar to that of the obstacle determination system 23, only differences from the obstacle determination system 23 will be described below.

The obstacle determination system 27 includes a retention time extension unit 28 and an obstacle determination unit 29. The retention time extension unit 28 and the obstacle determination unit 29 may be implemented as functional modules by the BCU 14 executing a predetermined program.

In the obstacle determination system 27, the high-pass filter 25 performs the filtering process to extract detection signals including reflected wave intensities higher than a threshold of the reflected wave intensity, and outputs the extracted detection signals to the retention time extension unit 28. The retention time extension unit 28 performs the extension process by adding an additional time to the retention time of each of the extracted detection signals, and outputs the retention time of the detection signals after the extension process to the obstacle determination unit 29. The obstacle determination unit 29 compares the received retention time of the detection signals after the extension process with a determination time and determines whether the retention time of the detection signals after the extension process exceeds the determination time. If the retention time of the detection signals after the extension process does not exceed the determination time, the obstacle determination unit 29 determines that the object corresponding to the detection signals after the extension process is noise caused by a rough water surface, and outputs a determination result with a value of “0.” On the other hand, if the retention time of the detection signals after the extension process exceeds the determination time, the obstacle determination unit 29 determines that the object corresponding to the detection signals after the extension process is an obstacle, and outputs a determination result with a value of “1.”

According to an example embodiment, an extension process is performed in which an additional time is added to the retention time of each of detection signals extracted by the filtering process, and whether an object corresponding to the detection signals is an obstacle is determined based on the retention time of the detection signals after the extension process. In a situation where only reflected waves from the water surface are detected, a plurality of detection signals extracted by the filtering process occur intermittently. Therefore, even when the extension process is performed, the detection signals do not merge with each other, and the retention time of the detection signals after the extension process is not extended beyond the additional time. On the other hand, in a situation where a slow-speed buoy is detected as an obstacle, a plurality of detection signals extracted by the filtering process occur continuously and densely. Accordingly, when the extension process is performed, the detection signals merge with each other, and the retention time of the detection signals after the extension process (i.e., the merged detection signal) becomes significantly longer than a time obtained by adding the additional time to the retention time of a single detection signal. That is, even in a situation where reflected waves having intensities higher than the threshold of the reflected wave intensity are generated from the water surface, it becomes possible to clearly determine whether the situation corresponds to detecting only reflected waves from the water surface or detecting a slow-speed buoy, based on the retention time. As a result, it is possible to prevent reflected waves from the water surface from being erroneously determined as reflected waves from an obstacle, thus further improving the accuracy of obstacle detection by the millimeter-wave radar 6.

In an example embodiment, the additional time (extension amount of the retention time) used in the extension process and the determination time used in the obstacle determination process may be changed depending on circumstances.

For example, the additional time and the determination time may be changed in accordance with the reliability of the detection signals. Specifically, when reflected waves having high intensity are frequently generated from objects other than obstacles and the reliability of the detection signals is low, it may be necessary to determine more carefully whether the object corresponding to the detection signals is an obstacle. Therefore, as the reliability of the detection signals decreases, the determination time may be set longer; for example, the determination time may be set longer as the water surface on which the marine vessel 1 is located becomes rougher. Alternatively, as the reliability of the detection signals decreases, the additional time may be set shorter; for example, the additional time may be set shorter as the water surface on which the marine vessel 1 is located becomes rougher.

In addition, since an object closer to the water surface is more likely to be noise caused by the water surface, the determination time may be set longer as the altitude of the object decreases so as to reduce the likelihood that an object close to the water surface is determined to be an obstacle. For example, when the altitude of the object is lower than a predetermined altitude, the determination time may be set longer than when the altitude of the object is equal to or higher than the predetermined altitude. Alternatively, the additional time may be set shorter as the altitude of the object decreases.

Furthermore, since reflected waves from an obstacle tend to have higher intensity than reflected waves corresponding to noise caused by the water surface, the additional time and the determination time may be changed in accordance with the intensity of the reflected waves in order to make it easier to determine an object corresponding to a detection signal having high reflected wave intensity as an obstacle. Specifically, as the reflected wave intensity increases, the additional time may be set longer and/or the determination time may be set shorter. Conversely, as the reflected wave intensity decreases, the additional time may be set shorter and/or the determination time may be set longer.

In an example embodiments described above, it is determined, in the filtering process and the obstacle determination process, whether an object corresponding to a detection signal is noise caused by the water surface or an obstacle. However, the noise is not limited to that caused by the water surface and may be, for example, noise caused by rainfall.

In addition, in an example embodiment described above, the millimeter-wave radar 6 detects objects around the marine vessel 1. However, the marine vessel 1 may be provided with a microwave radar instead of the millimeter-wave radar 6, and objects around the marine vessel 1 may be detected by the microwave radar. Furthermore, objects around the marine vessel 1 may be detected by a sensor different from a radar; for example, light detection and ranging (LiDAR) may be used to detect objects around the marine vessel 1.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An obstacle detection system for a marine vessel, the obstacle detection system comprising:
a sensor to detect a plurality of objects and output a plurality of detection signals; and
a controller configured or programmed to determine whether each of the objects is an obstacle based on the plurality of detection signals; wherein
the controller is configured or programmed to:
extract, from the plurality of detection signals, a detection signal having an intensity higher than a threshold;
extend a retention time of the extracted detection signal; and
determine whether an object among the plurality of objects is an obstacle based on a comparison between the extended retention time of the extracted detection signal and a determination time.

2. The obstacle detection system according to claim 1, wherein the controller is configured or programmed to change an extension amount of the retention time of the extracted detection signal in accordance with the intensity of the extracted detection signal.

3. The obstacle detection system according to claim 2, wherein the controller is configured or programmed to increase the extension amount of the retention time of the extracted detection signal as the intensity of the extracted detection signal increases.

4. The obstacle detection system according to claim 1, wherein, when extended retention times of two extracted detection signals that are temporally adjacent overlap at least partially, the controller is configured or programmed to:
merge the extended retention times of the two extracted detection signals; and
determine whether the object is an obstacle based on a comparison between a retention time resulting from merging the extended retention times and the determination time.

5. The obstacle detection system according to claim 1, wherein, when determining whether the object is an obstacle based on a comparison between the extended retention time of the extracted detection signal and the determination time, the controller is configured or programmed to set the determination time longer as the intensity of the detection signal to be compared decreases.

6. The obstacle detection system according to claim 1, wherein, when determining whether the object is an obstacle based on a comparison between the extended retention time of the extracted detection signal and the determination time, the controller is configured or programmed to set the determination time longer as a reliability of the detection signal to be compared decreases.

7. The obstacle detection system according to claim 1, wherein, when determining whether an object is an obstacle based on a comparison between the extended retention time of the extracted detection signal and the determination time, the controller is configured or programmed to set the determination time longer when an altitude of the object corresponding to the detection signal to be compared is lower than a predetermined altitude than when the altitude is equal to or higher than the predetermined altitude.

8. The obstacle detection system according to claim 1, wherein, when determining whether an object is an obstacle based on a comparison between the extended retention time of the extracted detection signal and the determination time, the controller is configured or programmed to set the determination time longer as a water surface on which the marine vessel is located becomes rougher.

9. The obstacle detection system according to claim 1, wherein the controller is configured or programmed to change the threshold in accordance with a condition of a water surface on which the marine vessel is located.

10. The obstacle detection system according to claim 9, wherein the controller is configured or programmed to set the threshold higher as the water surface on which the marine vessel is located becomes rougher.

11. The obstacle detection system according to claim 10, wherein the controller is configured or programmed to determine a roughness of the water surface on which the marine vessel is located based on at least one of a pitch angle of the marine vessel, a roll angle of the marine vessel, a vertical acceleration of the marine vessel, or a wind speed around the marine vessel.

12. The obstacle detection system according to claim 9, wherein the threshold is defined by a map that uses, as a parameter, at least one of a pitch angle of the marine vessel, a roll angle of the marine vessel, a vertical acceleration of the marine vessel, or a wind speed around the marine vessel.

13. An obstacle detection system for a marine vessel, the obstacle detection system comprising:
a sensor to detect a plurality of objects and output a plurality of detection signals; and
a controller configured or programmed to determine whether each of the objects is an obstacle based on the plurality of detection signals; wherein
the controller is configured or programmed to:
determine that an object corresponding to a detection signal having an intensity equal to or higher than a threshold is an obstacle; and
change the threshold in accordance with a condition of a water surface on which the marine vessel is located.

14. An obstacle detection method for a marine vessel, the method comprising:
detecting a plurality of objects and outputting a plurality of detection signals by a sensor; and
determining whether each of the objects is an obstacle based on the plurality of detection signals; wherein
the determining includes:
extracting, from the plurality of detection signals, a detection signal having an intensity equal to or higher than a threshold;
extending a retention time of the extracted detection signal; and
determining whether the object is an obstacle based on a comparison between the extended retention time of the extracted detection signal and a determination time.
